(19) United States
(12) Patent Application Publication
(10) Pub. No.: US 2020/0196396 A1
(43) Pub. Date: Jun. 18, 2020

(54) COOKING SYSTEM

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jorge Mir Bel, Zaragoza (ES); Julio Rivera Peman, Cuarte de Huerva (Zaragoza) (ES)

(21) Appl. No.: 16/629,043

(22) PCT Filed: Jun. 20, 2018
(86) PCT No.: PCT/IB2018/054537

§ 371 Date: Jan. 7, 2020

(30) Foreign Application Priority Data
Jul. 11, 2017 (ES) P201730913

(51) Int. Cl. H05B 6/06; H05B 6/12; F24C 7/08; A47J 36/32; A23L 5/10

(52) U.S. Cl. CPC H05B 6/062; H05B 6/1236; H05B 6/1218; F24C 7/082; A23V 2002/00; A23L 5/15; H05B 2213/03; H05B 2213/07; H05B 2213/06; A47J 36/321

(57) ABSTRACT

A cooking system includes a hot plate having a region for setting down of a cooking pot, and a display unit arranged at least partially in a region close to the region for setting down a cooking pot, when being viewed in a vertical direction onto a main extension plane of the hot plate. The display unit is operated in an operating state by a control unit as a function of at least one operation request parameter.

The invention relates to a cooking system as claimed in claim 1 and a method for operating a cooking system as claimed in claim 14.

An embodiment comprising a hot plate which defines a region for setting down a cooking pot is already known from the prior art. A display unit is arranged in a region close to the region for setting down a cooking pot, said display unit in a heating operating state displaying a temperature and comprising a thermochromic element.

The object of the invention, in particular, is to provide a generic device which has improved properties regarding operating comfort. The object is achieved according to the invention by the features of claims 1 and 14, whilst advantageous embodiments and developments of the invention may be derived from the subclaims.

A cooking system is proposed, comprising at least one hot plate defining at least one region for setting down a cooking pot, at least one display unit which is arranged at least partially in a region close to the region for setting down a cooking pot, when being viewed in a vertical direction down onto a main extension plane of the hot plate, and at least one control unit which is provided to operate the display unit in at least one operating state, as a function of at least one operation request parameter.

By means of such an embodiment, in particular, a high level of operating comfort may be achieved. In particular, a simple and/or intuitive operation may be permitted. A time which has to be taken for a cooking process may, in particular, be kept short since a user is continually informed, in particular by the control unit, by means of the display unit, about upcoming tasks to be carried out by the user, whereby in particular the probability of forgetting a task may be additionally avoided. In particular, it is possible to comply with a current trend which, in particular, consists in the use of display units, whereby in particular an integration of novel properties relative to user-friendliness and/or an integration of novel properties associated with emotional behavior may be achieved.

A “cooking system” is intended to be understood, in particular, as a system which comprises at least one component of a hob and/or at least one hob and/or at least one accessory unit which is provided for use in combination with a hob and/or at least one cooking pot which is provided to be heated by a hob.

A “hot plate” is intended to be understood, in particular, as a unit which is provided in at least one operating state for setting down a cooking pot and which, in particular, is provided to form a part of a hot plate external housing, in particular at least one hob comprising the hot plate. In particular, in an installed position the hot plate forms a part of the hob external housing facing a user. The hot plate consists, in particular, at least to a large part of glass and/or glass-ceramic. “At least to a large part” is intended to be understood, in particular, as a proportion of at least 70%, in particular of at least 80%, advantageously of at least 90% and preferably of at least 95%.

A “region for setting down a cooking pot” is intended to be understood, in particular, as a two-dimensional region on which in at least one operating state at least one cooking pot is able to be set down for heating the cooking pot and below which, when being viewed in a vertical direction down onto a main extension plane of the hot plate, in an installed position at least one heating element is arranged, said heating element, in particular, heating the cooking pot in the operating state. A “main extension plane” of an object is intended to be understood, in particular, as a plane which is parallel to a largest side surface of a smallest imaginary geometric cuboid which only just entirely encloses the object and, in particular, runs through the central point of the cuboid.

In particular, the cooking system comprises at least one heating element and, in particular, at least two, advantageously at least four, particularly advantageously at least eight, preferably at least twelve and particularly preferably a plurality of induction heating elements which in an installed position, in particular, is/are arranged below the hot plate. In particular, the induction heating elements are arranged in the form of a matrix. An “induction heating element” is intended to be understood in this connection, in particular, as an element which is provided to convert energy, preferably electrical energy, into heat and, in particular, to supply at least one cooking pot with this energy. Advantageously, the induction heating element is provided to generate an alternating electromagnetic field, in particular, at a frequency of between 20 kHz and 100 kHz which, in particular, is provided to be converted by eddy current induction and/or the effects of magnetic reversal into heat, in an in particular metal, preferably ferromagnetic, cooking pot base which has been set down.

A “display unit” is intended to be understood, in particular, as a unit which is provided, in particular, to provide at least one characteristic variable to a user, at least optically and/or acoustically and/or haptically. The characteristic variable could, for example, be an item of information and/or a time and/or a user request and/or a task request. Advantageously, the display unit could be provided to provide an optical output, such as for example a display of at least one image and/or at least one text and/or at least one number and/or at least one animation and/or at least one illumination. In particular, the display unit could have at least one lighting element, advantageously at least one LED, and/or in particular preferably a back-lit display, in particular a matrix display and/or a liquid crystal display and/or an LCD display and/or an OLED display and/or electronic paper. For example, the display unit could additionally be provided, in particular, to output at least one acoustic signal and/or, in particular, at least one acoustic sequence, such as for example a ring tone and/or a warning signal and/or a request in the form of, in particular, a prepared phrase. For example, the display unit could have at least one sound-emitting means which, in particular, could be a loudspeaker.

The display unit, in particular, comprises at least three, advantageously at least four, particularly advantageously at least eight, preferably at least twelve and particularly preferably a plurality of lighting elements. In particular, the display unit comprises a maximum of 100, in particular a maximum of 80, advantageously a maximum of 60, particularly advantageously a maximum of 50 and preferably a maximum of 40 lighting elements.

A “region close to” the region for setting down a cooking pot is intended to be understood, in particular, as a two-dimensional region which, when being viewed in a vertical direction down onto a main extension plane of the hot plate, contains the region for setting down a cooking pot and which extends in the direction, in particular in at least one, in particular any, direction, over an extent of a maximum of 25%, in particular a maximum of 20%, advantageously a maximum of 15%, particularly advantageously a maximum of 10% and preferably a maximum of 5% of a maximum extent of the region for setting down a cooking pot.

The expression that the display unit, when being viewed in a vertical direction down onto a main extension plane of the hot plate, is arranged at least “partially” in a region close to the region for setting down a cooking pot, is intended to be understood, in particular, that the display unit has at least one lighting element which, when being viewed in a vertical direction down onto a main extension plane of the hot plate, is arranged in the region close to the region for setting down a cooking pot and in that the display unit, in particular, could comprise at least one further lighting element which, when being viewed in a vertical direction down onto a main extension plane of the hot plate, could be arranged outside the region close to the region for setting down a cooking pot.

A “control unit” is intended to be understood, in particular, as an electronic unit which is preferably provided to control and/or to regulate at least the display unit. Preferably, the control unit comprises a computing unit and, in particular in addition to the computing unit, a memory unit with a control and/or regulating program stored therein, which is provided to be executed by the computing unit. For example, the control unit could be at least partially integrated in a control and/or regulating unit of a hob.

The cooking system could comprise, for example, at least one sensor, in particular at least one temperature sensor, which in particular could communicate with the control unit and which, in particular, could detect a temperature of a cooking pot set down in the region for setting down a cooking pot. The control unit could, in particular additionally by means of the display unit, output at least one further parameter and/or at least one further item of information to a user, such as for example a temperature and/or a heating power and/or an activation of at least one sensor of the cooking system.

An “operation request parameter” is intended to be understood, in particular, as a parameter by means of which the control unit requests a user via the display unit to perform a task and/or activity and/or by means of which the control unit outputs via the display unit to a user a remaining time in which a task and/or activity may be undertaken.

“Provided” is intended to be understood, in particular, as specifically programmed, designed and/or equipped. An object being provided for a specific function is intended to be understood as the object fulfilling and/or executing this specific function in at least one use state and/or operating state.

It is further proposed that the cooking system comprises at least one supply unit which in the operating state individually supplies each lighting element of the display unit with energy. In particular, each lighting element of the display unit is able to be activated separately. The supply unit has for each lighting element, in particular, at least one power circuit which is electrically separate from further power circuits of further lighting elements. A “supply unit” is intended to be understood, in particular, as a unit which in at least one operating state, in particular as a function of an activation of the supply unit by the control unit, provides electrical energy to at least one further subassembly, in particular to each lighting element of the display unit. As a result, in particular, a high level of flexibility and/or a high variety of design options may be provided. In particular, a plurality of different display patterns may be provided, whereby a plurality of items of information may be transmitted to a user.

Additionally, it is proposed that the cooking system comprises at least one setting down unit which in the operating state is arranged in the region for setting down a cooking pot. A “setting down unit” is intended to be understood, in particular, as a unit which is specifically provided for setting down in the region for setting down a cooking pot and namely, in particular, relative to at least one material property and/or a heating resistance and/or a size. In particular, the setting down unit may be specifically configured for the cooking system and/or provided for the cooking system. In the operating state, the setting down unit and the region for setting down a cooking pot, when being viewed in a vertical direction down onto a main extension plane of the hot plate, are arranged so as to overlap with one another. Advantageously, in the operating state the region for setting down a cooking pot, when being viewed in a vertical direction down onto a main extension plane of the hot plate, contains the setting down unit. As a result, in particular, a particularly high level of operating comfort may be achieved.

Moreover, it is proposed that the setting down unit comprises at least one cooking pot. As a result, in particular, an optimal cooking and/or preparation of food to be cooked which is located in the cooking pot may be achieved, whereby in particular a high level of user satisfaction and/or a low return rate may be permitted.

For example, the setting down unit could exclusively comprise a cooking pot, wherein in particular a pad unit could be dispensed with. Preferably, in particular alternatively or additionally to the cooking pot, the setting down unit comprises at least one pad unit which in the operating state is arranged between at least one cooking pot, which in particular could be part of the setting down unit and/or different from the setting down unit, and the hot plate. A “pad unit” is intended to be understood, in particular, as a unit which is provided for setting down and/or positioning, in particular for placing, on the hot plate, and for setting down at least one cooking pot and which, in particular, in the operating state at least partially forms a pad for the heated cooking pot. In an installed position the pad unit is provided, in particular, for placing above the hot plate. The phrase that in the operating state the pad unit is arranged “between” at least one cooking pot and the hot plate, is intended to be understood, in particular, that a shortest connection between, in particular, any point of the cooking pot, in particular a cooking pot base of the cooking pot, and the hot plate passes through the pad unit and, in particular, intersects the pad unit at least once. In particular, in the operating state the pad unit is at least substantially provided to prevent a transmission of heat from the cooking pot to the hot plate. In particular, the pad unit is provided in the operating state to provide at least a heat insulation and/or a heat sink. The pad unit has, in particular, a heat-insulating material and/or a material with a relatively high specific heat capacity and preferably consists at least to a large part of the material. For example, the pad unit could consist at least to a large part of rubber and/or silicone. Advantageously, the pad unit consists at least to a large part of a material with a specific heat capacity of at least 800 J/(kg*K), in particular of at least 1000 J/(kg*K), advantageously of at least 1200 J/(kg*K), particularly advantageously of at least 1400 J/(kg*K), preferably of at least 1500 J(kg*K) and particularly preferably of at least 1600 J/(kg*K). Alternatively or additionally, the pad unit consists to a large part of a material with a heat conductivity of a maximum of 1W/(m*K), in particular a maximum of 0.8 W/(m*K), advantageously a maximum of 0.5 W/(m*K), particularly advantageously a maximum of 0.3W/(m*K), preferably a maximum of 0.2 W/(m*K) and particularly preferably a maximum of 0.16 W/(m*K). The pad unit consists, in particular, at least to a large part of a substantially flexible and/or resilient material. The material, for example, could be rubber and/or silicone. As a result, damage to the hot plate in the operating state could be prevented, whereby in particular a durable embodiment may be permitted.

Additionally, it is proposed that the display unit is at least partially integrated in the setting down unit, in particular in the cooking pot and/or in the pad unit of the setting down unit. The phrase that the display unit is at least “partially” integrated in a further subassembly is intended to be understood, in particular, that the display unit has at least one lighting element which is integrated in the further subassembly and that the display unit could have at least one further lighting element, which could be arranged outside and/or separately from the further subassembly. At least one part of the display unit, which in particular could be integrated in the further subassembly, could be surrounded, in particular relative to a central point and/or point of gravity of the part of the display unit, by an angular range of at least 180°, in particular of at least 270°, advantageously of at least 300° and preferably of at least 330° of the further subassembly. The further subassembly could consist at least to a large part of at least one transparent material in the region in which at least one part of the display unit could be integrated. At least one part of the display unit, which in particular could be integrated in the further subassembly, could alternatively or additionally be arranged and/or fastened on a surface of the further subassembly. As a result, the display unit, in particular, may be positioned so as to be clearly visible to a user, whereby in particular a high level of operating comfort may be permitted.

In the operating state the display unit could be arranged at least partially below the region close to the region for setting down a cooking pot. For example, the display unit could be exclusively integrated in the cooking pot or in the pad unit. Alternatively, the display unit could be integrated, in particular, at least partially in the cooking pot and the pad unit. Advantageously, in the operating state the display unit is at least partially arranged below the region close to the region for setting down a cooking pot. In particular, in the operating state the display unit could be integrated at least partially in the hot plate, and advantageously surrounded by the hot plate over an angular range of at least 180°, in particular of least 270°, advantageously of at least 300° and preferably of at least 330°, and namely in particular relative to any selected plane. Alternatively or additionally, in the operating state the display unit could be arranged at least partially below the hot plate. The phrase that the display unit is arranged at least “partially” below a further object, is intended to be understood, in particular, that the display unit has at least one lighting element which in the operating state is arranged below the further object and in that the display unit could have at least one further lighting element which in the operating state could be arranged above the further object. In particular, the cooking system could have at least one pot recognition unit which in at least one operating state, in particular, could communicate with the control unit and, as a function thereof, the control unit could operate, in particular, the display unit. As a result, the display unit may be arranged, in particular, so as to be specifically protected, in particular, from contaminants produced in a cooking process, whereby in particular a durable embodiment may be achieved.

For example, the supply unit, which in the operating state supplies, in particular, each lighting element of the display unit individually with energy, may have at least one battery and/or at least one rechargeable battery. The cooking system has at least one induction heating element which in the operating state is arranged below the hot plate and supplies the display unit with, in particular, electrical energy. In particular, the induction heating element supplies the display unit with electrical energy by the inductive transmission of energy and namely, in a case of an at least partial integration of the display unit in the setting down unit, through the hot plate. The induction heating element is, in particular, at least partially integrally configured with the supply unit. In particular, the induction heating element forms at least a part of the supply unit, wherein the cooking system could have at least one further induction heating element which, in particular, could form a further part of the supply unit. In particular, in an operating state, a positioning of the setting down unit above the induction heating element may be output by means of the display unit and namely in particular by the energy available from the induction heating element. In particular, the cooking system could have at least two induction heating elements which, for example, form a common heating zone and/or could be arranged in the form of a matrix and which, in particular, could together supply the display unit with energy. As a result, in particular batteries and/or rechargeable batteries may be dispensed with, whereby in particular an environmentally friendly embodiment may be achieved.

Additionally, it is proposed that the display unit has a plurality of lighting elements and the induction heating element in the operating state supplies each lighting element individually with energy. In particular, each lighting element of the display unit is separately activatable. In particular, at least one power circuit, which is electrically separate from further power circuits for further lighting elements, is present for each lighting element. As a result, in particular, a high level of flexibility and/or a large variety of design options may be provided. In particular, a plurality of different display patterns may be provided, whereby a plurality of items of information may be transmitted to a user.

It is further proposed that in an operating state the induction heating element, when being viewed in a vertical direction down onto a main extension plane of the hot plate, when the setting down unit is set down, exclusively activates lighting elements of the display unit arranged in the region close to the region for setting down a cooking pot. In particular, in the operating state the induction heating element, when being viewed in a vertical direction down onto a main extension plane of the hot plate, when the setting down unit is set down, exclusively activates lighting elements of the display unit arranged within a surface spanned by the induction heating element. As a result, in particular, a display of an optimal setting down position may be permitted, whereby in particular losses due to an inaccurate setting down of the setting down unit may be avoided.

It is further proposed that the operation request parameter is a user request relative to setting down in the region for setting down a cooking pot. In particular, the operation request parameter is at least one item of information about a setting down position in the region for setting down a cooking pot. The control unit displays in the operating state, in particular to a user by means of the display unit, a setting down of the setting down unit in the region for setting down a cooking pot and requests the user thereby, in particular, to start a cooking process. In particular, the control unit displays in the operating state, in particular, to a user by means of the display unit, in particular in the case of an exclusively partial setting down of the setting down unit in the region for setting down a cooking pot, at least one degree of overlap of the setting down unit with the region for setting down a cooking pot and/or at least one direction in which the setting down unit relative to the region for setting down a cooking pot should be displaced, in order in particular to achieve a complete setting down of the setting down unit in the region for setting down a cooking pot. In an operating state, when being viewed in a vertical direction down onto a main extension plane of the hot plate, the control unit could, in particular, output a degree of overlap of the setting down unit with the induction heating element by differently colored lighting elements of the display unit and/or by a flashing of the display unit and/or by a deactivation of the display unit. For example, in an operating state, when being viewed in a vertical direction down onto a main extension plane of the hot plate, the control unit could, in particular, output a complete overlap of the setting down unit with the induction heating element by a green color of the lighting elements of the display unit. For example, in an operating state, when being viewed in a vertical direction down onto a main extension plane of the hot plate, the control unit could, in particular, output a partial overlap of the setting down unit with the induction heating element by a flashing of the lighting elements of the display unit. For example, in an operating state, when being viewed in a vertical direction down onto a main extension plane of the hot plate, the control unit could, in particular, output an arrangement of the setting down unit outside and/or at least to a large part outside the induction heating element by a deactivation of the display unit. As a result, in particular, a more rapid cooking process may be permitted and/or losses due to an inaccurate setting down of the setting down unit in the region for setting down a cooking pot may be avoided. In particular, a setting down of a cooking pot in an optimal position in the region for setting down a cooking pot may be permitted in a simple and/or intuitive manner and namely in particular in the case of a hot plate which is free of markings. In particular, a user may optimally position the setting down unit in the region for setting down a cooking pot by feedback communicated by means of the display unit, whereby in particular an optimized heating may be carried out.

Additionally, it is proposed that the operation request parameter is a user request relative to a cooking process, in particular relative to a cooking status and/or a timer. In particular, the operation request parameter is at least one item of information about a cooking process. In the operating state, the control unit displays, in particular to a user by means of the display unit, at least one item of information relative to a cooking sequence and requests the user thereby, in particular, to perform a task. For example, the control unit could request the user by means of the display unit, in particular in the case of a timer which has expired, to remove the cooking pot from the region for setting down a cooking pot, in order for example to eat cooked food which has been cooked in the cooking pot. Alternatively or additionally, the control unit could request the user by means of the display unit to initiate and/or prepare at least one further step in the cooking process, such as for example adding at least one ingredient and/or reducing a heating power. The cooking status could, for example, be a cooking and/or simmering and/or boiling process. As a result, in particular, a particularly high level of operating comfort may be achieved.

It is further proposed that the operation request parameter is a user request relative to a cooking recipe, in particular relative to adding at least one ingredient. In particular, the operation request parameter is at least one item of information about a cooking recipe. The control unit displays in the operating state, in particular, to a user by means of the display unit at least one item of information relative to a cooking recipe and requests the user thereby, in particular, to perform a task, such as in particular adding at least one ingredient. As a result, in particular, a convenient and/or simple preparation of cooked food may be permitted. In particular, there is a small probability of adding ingredients too late, whereby in particular an optimal cooking result may be achieved.

It is further proposed that the operation request parameter is a user request to remove undesired objects from the region for setting down a cooking pot. In particular, the operation request parameter is at least one item of information about an object located in the region for setting down a cooking pot. In the operating state, the control unit displays, in particular, to a user by means of the display unit whether an undesired object is located in the region for setting down a cooking pot and requests the user thereby, in particular, to perform a task to remove the undesired object from the region for setting down a cooking pot. As a result, in particular, a high standard of safety may be ensured. In particular, dangerous situations may be avoided since undesired objects, in particular, may negatively influence a cooking process and/or a heating.

A particularly high level of operating comfort may be achieved, in particular, by a method for operating a cooking system comprising at least one hot plate defining at least one region for setting down a cooking pot and at least one display unit which is arranged at least partially in a region close to the region for setting down a cooking pot, when being viewed in a vertical direction down onto a main extension plane of the hot plate, wherein at least one operation request parameter is output by means of the display unit in at least one operating state.

The cooking system in this case is not intended to be limited to the above-described application and embodiment. In particular, for fulfilling a mode of operation described herein, the cooking system may have a number of individual elements, components and units which differs from the number cited herein.

Further advantages are disclosed from the following description of the drawings. Exemplary embodiments of the invention are shown in the drawings. The drawings, the description and the claims contain numerous features in combination. The person skilled in the art will expediently consider the features individually and combine them together to form further meaningful combinations.

### IN THE DRAWINGS

FIG. 1 shows a cooking system with a hot plate, with a user interface, with a control unit, with a display unit and with a setting down unit out of an operating state in a schematic plan view,

FIG. 2 shows an enlarged detail of the cooking system in an operating state in a schematic plan view, wherein the activated lighting elements of the display unit are shown hatched,

FIG. 3 shows the enlarged detail of the cooking system in the operating state in a schematic sectional view, wherein activated lighting elements of the display unit are shown hatched,

FIG. 4 shows an enlarged detail of the cooking system in a further operating state in a schematic plan view, wherein activated lighting elements of the display unit are shown hatched,

FIG. 5 shows the enlarged detail of the cooking system in the further operating state in a schematic sectional view, wherein activated lighting elements of the display unit are shown hatched,

FIG. 6 shows an alternative cooking system with a hot plate, with a display unit and with a setting down unit in an operating state in a schematic plan view,

FIG. 7 shows the cooking system of FIG. 6 with the hot plate, with the display unit and with the setting down unit in an operating state in a schematic plan view,

FIG. 8 shows the cooking system of FIG. 6 with the hot plate, with the display unit and with the setting down unit in an operating state in a schematic plan view,

FIG. 9 shows the cooking system of FIG. 6 with the hot plate, with the display unit and with the setting down unit in an operating state in a first remaining timespan in a schematic plan view,

FIG. 10 shows the cooking system of FIG. 6 with the hot plate, with the display unit and with the setting down unit in the operating state in a second remaining timespan in a schematic plan view,

FIG. 11 shows the cooking system of FIG. 6 with the hot plate, with the display unit and with the setting down unit in the operating state in a third remaining timespan in a schematic plan view,

FIG. 12 shows the cooking system of FIG. 6 with the hot plate, with the display unit and with the setting down unit in an operating state in a first preparation step of a cooking recipe in a schematic plan view,

FIG. 13 shows the cooking system of FIG. 6 with the hot plate, with the display unit and with the setting down unit in an operating state in a second preparation step of the cooking recipe in a schematic plan view,

FIG. 14 shows the cooking system of FIG. 6 with the hot plate, with the display unit and with the setting down unit in an operating state in a third preparation step of the cooking recipe in a schematic plan view,

FIG. 15 shows the cooking system of FIG. 6 with the hot plate, with the display unit and with the setting down unit in an operating state in a fourth preparation step of the cooking recipe in a schematic plan view,

FIG. 16 shows an alternative cooking system with a hot plate, with a display unit and with an induction heating element and with a setting down unit in an operating state in a schematic plan view,

FIG. 17 shows the cooking system of FIG. 16 with the hot plate, with the display unit, with the induction heating element and with the setting down unit in an operating state in a schematic plan view,

FIG. 18 shows the cooking system of FIG. 16 with the hot plate, with the display unit, with the induction heating element and with the setting down unit in an operating state in a schematic plan view,

FIG. 19 shows the cooking system of FIG. 16 with the hot plate, with the display unit, with the induction heating element and with the setting down unit in an operating state in a schematic plan view,

FIG. 20 shows an alternative cooking system in an operating state in a schematic plan view,

FIG. 21 shows the cooking system of FIG. 20 in the operating state in a schematic partial sectional view,

FIG. 22 shows the cooking system of FIG. 20 in an operating state in a schematic plan view,

FIG. 23 shows the cooking system of FIG. 20 in the operating state in a schematic partial sectional view,

FIG. 24 shows an alternative cooking system in an operating state in a schematic plan view,

FIG. 25 shows the cooking system of FIG. 24 in the operating state in a schematic partial sectional view,

FIG. 26 shows an alternative cooking system in an operating state in a schematic plan view,

FIG. 27 shows the cooking system of FIG. 26 in the operating state in a schematic partial sectional view,

FIG. 28 shows the cooking system of FIG. 26 in an operating state in a schematic plan view and

FIG. 29 shows the cooking system of FIG. 26 in the operating state in a schematic partial sectional view.

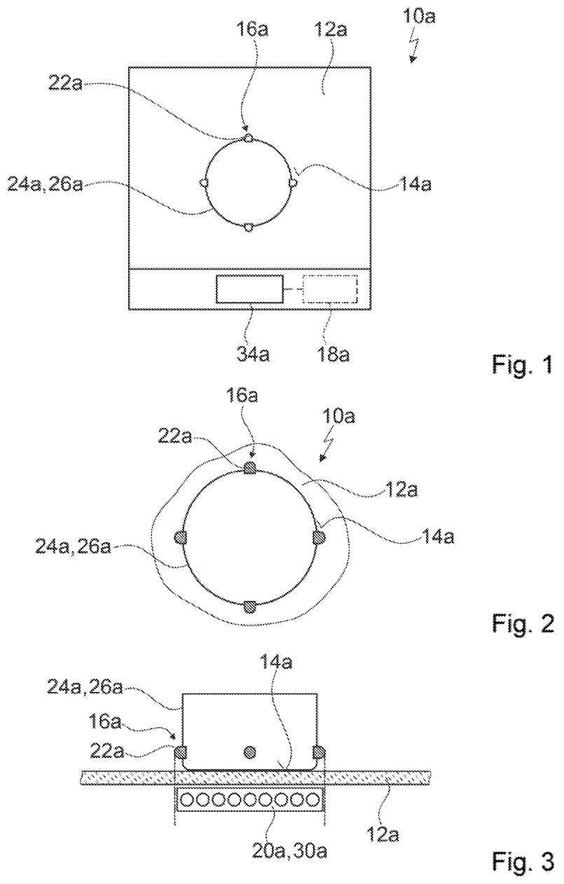

FIG. 1 shows a cooking system 10a. The cooking system 10a has a hot plate 12a. In a mounted state, the hot plate 12a forms a part of a hot plate external housing, in particular of the cooking system 10a. The hot plate 12a forms in an installed position a part of the hot plate external housing facing a user. In a mounted state, the hot plate 12a is provided for setting down a cooking pot 26a.

The hot plate 12a defines a region for setting down a cooking pot 14a. The region for setting down a cooking pot 14a is provided for setting down a cooking pot 26a. The region for setting down a cooking pot 14a is defined by a surface of the hot plate 12a.

The cooking system 10a has a user interface 34a for the input and/or selection of control parameters, for example a heating power and/or a heating power density and/or a heating zone. The user interface 34a is provided for the output of a value of a control parameter to a user. For example, the user interface 34a could optically and/or acoustically output the value of the control parameter to a user.

The cooking system 10a has a control unit 18a. The control unit 18a is provided to perform actions and/or alter settings, as a function of control parameters which are input by means of the user interface 34a. In an installed position the control unit 18a is arranged below the hot plate 12a.

The cooking system 10a has a plurality of induction heating elements 30a (see FIGS. 2 to 5). In the present exemplary embodiment only one of the induction heating elements 30a is shown. For example, the induction heating elements 30a could be arranged in series. Alternatively or additionally, the induction heating elements 30a could be arranged in the form of a matrix. The induction heating elements 30a could alternatively be arranged in the form of a conventional hob, in which each of the induction heating elements 30a, for example, could define and/or form a separate heating zone. Only one of the induction heating elements 30a is described hereinafter.

The induction heating element 30a is provided to heat a cooking pot set down on the hot plate 12a above the induction heating element 30a. In an operating state the induction heating element 30a, which in particular is activated, provides a magnetic flux which, in particular, is provided for heating a cooking pot 26a set down thereon. In an operating state, the induction heating element 30a, which in particular is activated, supplies energy to a cooking pot 26a which is set down, in particular by means of the magnetic flux provided by the induction heating element 30a. In an operating state the control unit 18a controls an energy supply, in particular, to the activated induction heating element 30a. In an installed position, the induction heating element 30a is arranged below the hot plate 12a and namely, in particular, below the region for setting down a cooking pot 14a of the hot plate 12a.

The cooking system 10a has a display unit 16a (see FIGS. 1 to 5). When being viewed in a vertical direction down onto a main extension plane of the hot plate 12a, the display unit 16a is partially arranged in a region close to the region for setting down a cooking pot 14a. In the present exemplary embodiment, the display unit 16a has four lighting elements 22a. The lighting elements 22a in the present exemplary embodiment are configured as LEDs. In each case, only one of the objects which are repeatedly present is provided with a reference numeral in the figures.

The cooking system 10a has a supply unit 20a (see FIGS. 2 to 5). In an operating state, the supply unit 20a supplies the display unit 16a with energy. In an operating state, the supply unit 20a supplies each lighting element 22a of the display unit 16a individually with energy.

In the present exemplary embodiment, the supply unit 20a is configured integrally with the induction heating element 30a. In an operating state, the induction heating element 30a supplies the display unit 16a with energy. In an operating state, the induction heating element 30a supplies each lighting element 22a of the display unit 16a individually with energy.

The cooking system 10a has a setting down unit 24a (see FIGS. 1 to 5). In an operating state, the setting down unit 24a is arranged in the region for setting down a cooking pot 14a. In the present exemplary embodiment, the setting down unit 24a comprises the cooking pot 26a. The setting down unit 24a is configured as the cooking pot 26a.

The display unit 16a is integrated in the setting down unit 24a. When being viewed in a vertical direction down onto a main extension plane of the hot plate 12a, the lighting elements 22a of the display unit 16a are arranged so as to be distributed substantially uniformly over a periphery of the setting down unit 24a.

In an operating state, the control unit 18a operates the display unit 16a as a function of an operation request parameter. In an operating state, the control unit 18a requests a user to perform a task as a result of the operation request parameter output by means of the display unit 16a.

In an operating state, the induction heating element 30a, in particular as a function of an activation by the control unit 18a, when being viewed in a vertical direction down onto a main extension plane of the hot plate 12a, when the setting down unit 24a is set down, exclusively activates the lighting elements 22a of the display unit 16a arranged in the region close to the region for setting down a cooking pot 14a. The operation request parameter is a user request relative to setting down in the region for setting down a cooking pot 14a.

In an operating state, a user sets down the setting down unit 24a in the region for setting down a cooking pot 14a (see FIGS. 2 and 3). In an operating state, the display unit 16a which is integrated in the setting down unit 24a is arranged above the induction heating element 30a. When being viewed in a vertical direction down onto a main extension plane of the hot plate 12a, the region for setting down a cooking pot 14a contains the setting down unit 24a. In the operating state, the induction heating element 30a activates each lighting element 22a of the display unit 16a.

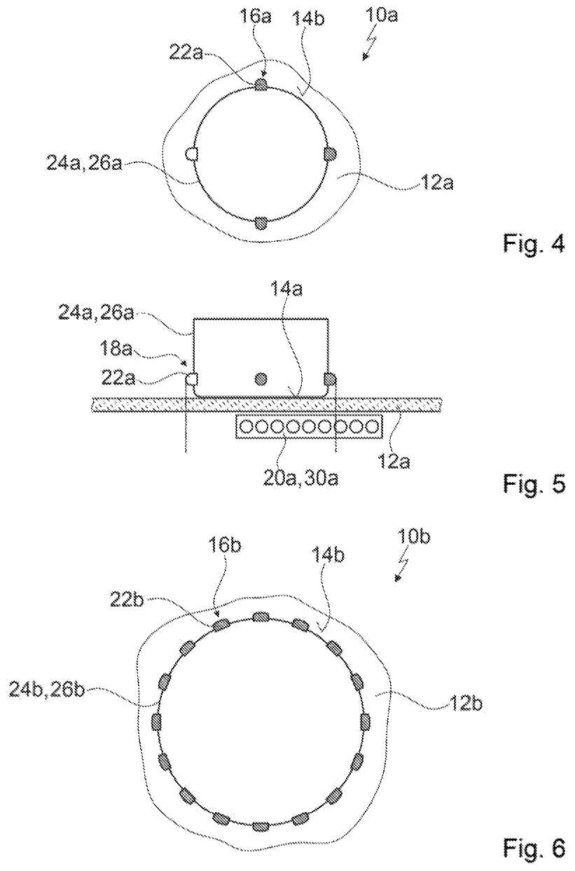

In an operating state, a user sets down the setting down unit 24a partially outside the region for setting down a cooking pot 14a (see FIGS. 4 and 5). In an operating state, the display unit 16a integrated in the setting down unit 24a is arranged at least partially above the induction heating element 30a. In the operating state, the display unit 16a integrated in the setting down unit 24a, when being viewed in a vertical direction down onto a main extension plane of the hot plate 12a, is arranged partially adjacent to the induction heating element 30a. In the operating state, the induction heating element 30a, in particular as a function of an activation by the control unit 18a, when being viewed in a vertical direction down onto a main extension plane of the hot plate 12a, when the setting down unit 24a is set down, exclusively activates lighting elements 22a of the display unit 16a arranged in the region close to the region for setting down the cooking pot 14a. The lighting elements 22a of the display unit 16a which, when being viewed in a vertical direction down onto a main extension plane of the hot plate 12a, are arranged outside the region for setting down a cooking pot 14a, are deactivated in the operating state. In the operating state, the control unit 18a requests a user by means of the display unit 16a to displace the setting down unit 24a and such that the setting down unit 24a, when being viewed in a vertical direction down onto a main extension plane of the hot plate 12a, is arranged in the region for setting down a cooking pot 14a.

In a method for an operation of the cooking system 10a, when being viewed in a vertical direction down onto a main extension plane of the hot plate 12a, the display unit 16a is partially arranged in the region close to the region for setting down a cooking pot 14a. In the operating state, an operation request parameter is output by means of the display unit 16a.

In FIGS. 6 to 29 further exemplary embodiments of the invention are shown. The following descriptions are substantially limited to the differences between the exemplary embodiments, wherein relative to components, features and functions which remain the same, reference may be made to the description of the exemplary embodiment of FIGS. 1 to 5. In order to differentiate between the exemplary embodiments, the letter a in the reference numerals of the exemplary embodiment in FIGS. 1 to 5 is replaced by the letters b to fin the reference numerals of the exemplary embodiments of FIGS. 6 to 29. Relative to components which are referenced the same, in particular relative to components with the same reference numerals, in principle reference may also be made to the drawings and/or the description of the exemplary embodiment of FIGS. 1 to 5.

FIG. 6 shows a cooking system 10b with a hot plate 12b which defines a region for setting down a cooking pot 14b. A display unit 16b of the cooking system 10b has a plurality of lighting elements 22b. In the present exemplary embodiment, the display unit 16b has sixteen lighting elements 22b. A control unit 18b of the cooking system 10b operates the display unit 16b as a function of an operation request parameter.

The operation request parameter is a user request relative to setting down in the region for setting down a cooking pot 14b. In an operating state, an induction heating element 30b of the cooking system 10b, in particular as function of an activation by the control unit 18b, when being viewed in a vertical direction down onto a main extension plane of the hot plate 12b, when a setting down unit 24b is set down, exclusively activates lighting elements 22b of the display unit 16b arranged in the region close to the region for setting down a cooking pot 14b.

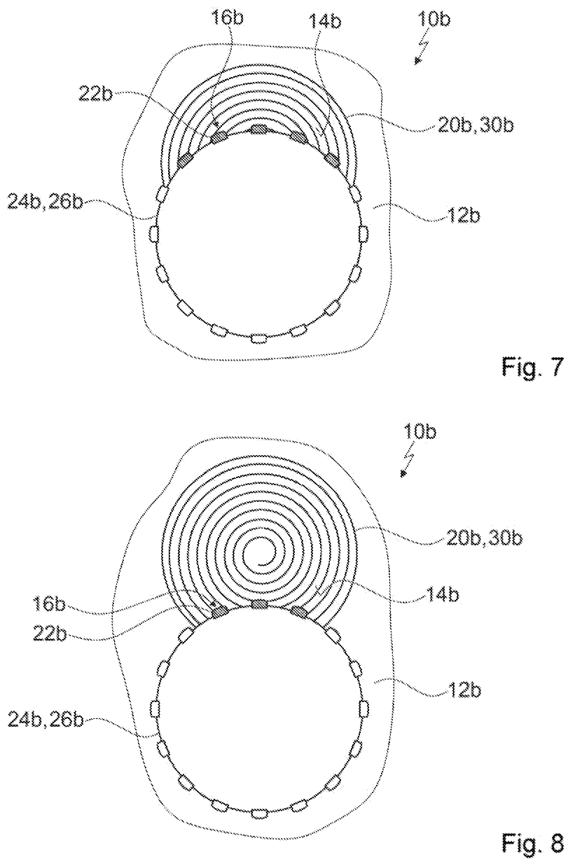

In an operating state in which the setting down unit 24b is entirely arranged in the region for setting down a cooking pot 14b, the induction heating element 30b, when being viewed in a vertical direction down onto a main extension plane of the hot plate 12b, when a setting down unit 24b is set down, activates all of the lighting elements 22b of the display unit 16b. When being viewed in a vertical direction down onto a main extension plane of the hot plate 12b, the induction heating element 30a activates a specific portion of lighting elements 22b of the display unit 16b (see FIGS. 7 and 8) as a function of an overlap of the setting down unit 24b with the region for setting down a cooking pot 14b.

In an operating state in which the setting down unit 24b is arranged in substantially 35% of the region for setting down a cooking pot 14b, the induction heating element 30b, when being viewed in a vertical direction down onto a main extension plane of the hot plate 12b, when a setting down unit 24b is set down, activates five lighting elements 22b of the display unit 16b (see FIG. 7). In an operating state in which the setting down unit 24b is arranged in substantially 20% of the region for setting down a cooking pot 14b, the induction heating element 30b, when being viewed in a vertical direction down onto a main extension plane of the hot plate 12b, when a setting down unit 24b is set down, activates three lighting elements 22b of the display unit 16b (see FIG. 8).

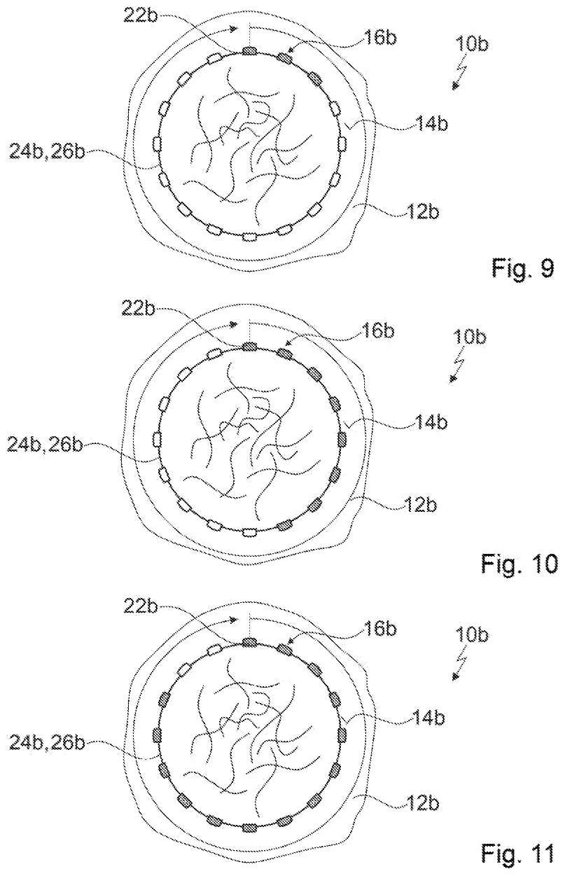

In the operating state, the control unit 18b informs a user by means of the display unit 16b about a remaining time until a task is undertaken by the user (see FIG. 9). In the operating state, the control unit 18b operates the display unit 16b as a function of an operation request parameter. The operation request parameter is a user request relative to a cooking process. In the operating state, the nearer it is to an end of a predetermined timespan the more lighting elements 22b of the display unit 16b are activated by the control unit 18b. In the operating state, the control unit 18b activates the lighting elements 22b of the display unit 16b at substantially uniform intervals which, in particular, are defined by a duration of the predetermined timespan and/or by a number of lighting elements 22b of the display unit 16b. In the operating state, the control unit 18b requests a user to perform a task by means of the display unit 16b once all of the lighting elements 22b of the display unit 16b are activated, and thus in particular once the predetermined timespan has elapsed.

In the case of a first timespan ti remaining until the predetermined timespan has elapsed, the control unit 18b activates, for example, three lighting elements 22b of the display unit 16b (see FIG. 9). In the case of a second timespan t₂<t₁ remaining until the predetermined timespan has elapsed, the control unit 18b activates, for example, eight lighting elements 22b of the display unit 16b (see FIG. 10). In the case of a third timespan t₃<t₂<t₁ remaining until the predetermined timespan has elapsed, the control unit 18b activates, for example, fourteen lighting elements 22b of the display unit 16b (see FIG. 11).

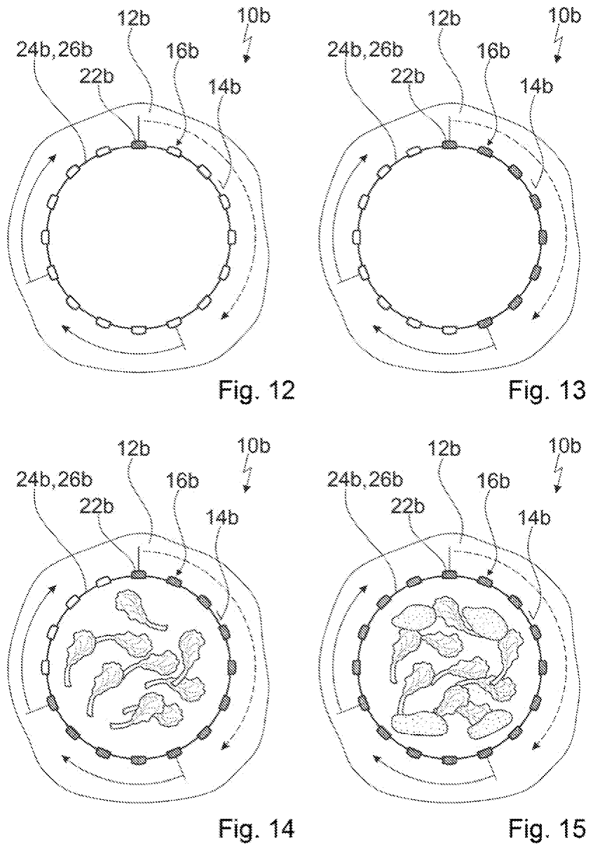

In an operating state, the control unit 18b guides a user by means of the display unit 16b through a cooking recipe (see FIGS. 12 to 15). For example, the control unit 18b could recall the cooking recipe from a memory unit of the control unit 18b and/or from a mobile device, such as for example a smartphone and/or a mobile phone, and/or a network, such as for example a domestic network and/or the Internet. The operation request parameter is a user request relative to a cooking recipe. In the operating state, the control unit 18b outputs by means of the display unit 16b different recipe steps using different colors of lighting elements 22b of the display unit 16b. The control unit 18b assigns a color to each recipe step.

Without limiting the generality of the invention, a cooking recipe with three ingredients is described in the present exemplary embodiment. At a start of the cooking recipe, in the operating state, the control unit 18b activates a lighting element 22b of the display unit 16b in a blue color in order to request a user, in particular, to add a first ingredient, such as for example water. After the addition of the first ingredient and, in particular, after a confirmation by the user that the first ingredient has been added, in the operating state the control unit 18b heats the first ingredient located in the setting down unit 24b which is configured as cooking pot 26b. In the operating state, when the temperature of the first ingredient rises, the control unit 18b activates a greater number of lighting elements 22b of the display unit 16b in a blue color until, in particular, substantially 33% of the lighting elements 22b of the display unit 16 are activated (see FIG. 13). By the flashing of the lighting elements 22b of the display unit 16b assigned to the first ingredient, the control unit 18b requests a user to add a second ingredient, such as for example spinach.

After the addition of the second ingredient and, in particular, after a confirmation by the user that the second ingredient has been added, in the operating state the control unit 18b heats the second ingredient located in the setting down unit 24b which is configured as a cooking pot 26b. The control unit 18b activates the lighting elements 22b assigned to the first ingredient continuously and, in particular, stops the flashing, whereby a user is always informed, in particular, about a status of the cooking recipe and, in particular, knows exactly which ingredients have already been added and/or what is the cooking status of the ingredient. In the operating state, when the temperature of the first ingredient rises, the control unit 18b activates a greater number of lighting elements 22b of the display unit 16 in the color which is assigned to the second ingredient until, in particular, substantially 66% of the lighting elements 22b of the display unit 16 are activated (see FIG. 14). The control unit 18b requests a user, by the flashing of the lighting elements 22b of the display unit 16b assigned to the second ingredient, to add a third ingredient, such as potatoes. After the completion of a cooking process of a last ingredient of the cooking recipe, the control unit 18b activates all of the lighting elements 22b of the display unit 16b in order to inform a user, in particular, about a task, such as for example a removal of the setting down unit 24b which is configured as a cooking pot 26b (see FIG. 15).

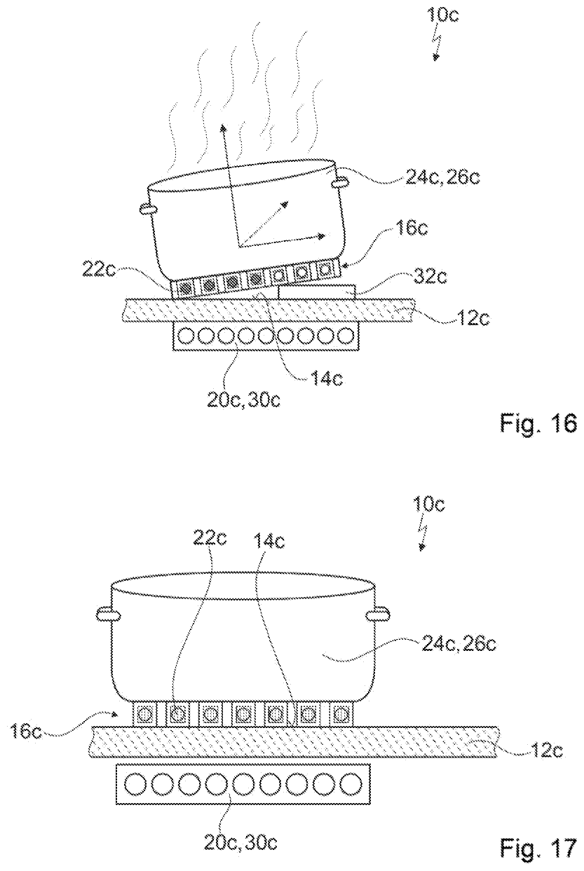

FIG. 16 shows a cooking system 10c with a hot plate 12c which defines a region for setting down a cooking pot 14c. A display unit 16c of the cooking system 10c has a plurality of lighting elements 22c. A control unit 18c of the cooking system 10c operates the display unit 16c as a function of an operation request parameter. The operation request parameter is a user request to remove undesired objects 32c from the region for setting down a cooking pot 14c.

In an operating state, a user may wish to set down a setting down unit 24c which is configured as a cooking pot 26c in the region for setting down a cooking pot 14c. An undesired object 32c, such as for example a coin, is located in the region for setting down a cooking pot 14c. A heating of the setting down unit 24c might be negatively influenced due to the undesired object 32c. The control unit 18c informs a user by means of the display unit 16c about the presence of the undesired object 32c and namely, in particular, by activating lighting elements 22c of the display unit 16c. In particular by activating an induction heating element 30c of the cooking system 10c, the control unit 18c activates lighting elements 22c of the display unit 16c arranged in the region for setting down a cooking pot 14c. In a region in which the undesired object 32c is arranged between the induction heating element 30c and the setting down unit 24c, an activation of the display unit 16c integrated in the setting down unit 24c is interrupted, which is why in an installed position lighting elements 22c of the display unit 16c arranged above the undesired object 32c remain deactivated. As a result, a user is informed about the presence of the undesired object 32c. The control unit 18c requests a user by means of the display unit 16c to remove the undesired object 32c from the region for setting down a cooking pot 14c.

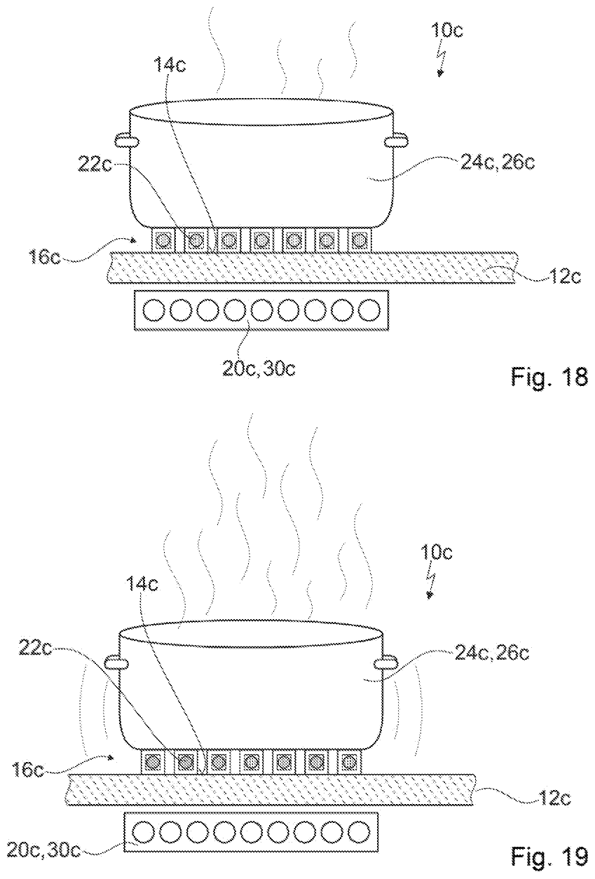

In an operating state, a user sets down a setting down unit 24c which is configured as a cooking pot 26c in the region for setting down a cooking pot 14c (see FIG. 17) and starts a cooking process. When the temperature of the setting down unit 24c, which is configured as a cooking pot 26c, rises, the control unit 18c alters an activation state of the display unit 16c. In the present exemplary embodiment, in the operating state the control unit 18c operates the display unit 16c with low intensity and/or brightness until a first temperature threshold is reached. The first temperature threshold could, for example, be 65° C. In the range from the first temperature threshold to a second temperature threshold, in the operating state the control unit 18c activates the display unit 16c with average intensity and/or brightness (see FIG. 18). The second temperature threshold could, for example, be 85° C. In the range above the second temperature threshold, in the operating state the control unit 18c activates the display unit 16c with the greatest intensity and/or brightness (see FIG. 19). As a result, in particular, a user may be prevented from being injured by burning.

In an operating state, a user sets down a setting down unit 24c, which is configured as a cooking pot 26c, in the region for setting down a cooking pot 14c (not shown) and starts a cooking process. The control unit 18c operates the display unit 16c as a function of a heating power and/or a temperature. In the present operating state the control unit 18c operates the display unit 16c with different predefined colors for different heating powers. In the operating state, the control unit 18c operates the display unit 16c with different predefined colors for different temperatures which, in particular, differ from the different predefined colors for different heating powers. As a result, in particular, a user may be continuously informed about a current status.

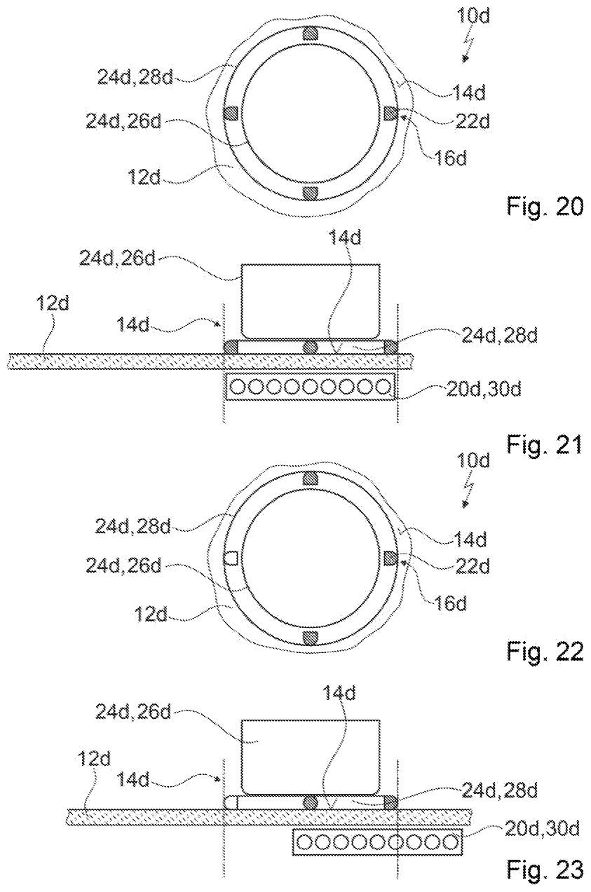

FIG. 20 shows a cooking system 10d with a hot plate 12d, which defines a region for setting down a cooking pot 14d, and with an induction heating element 30d which is integrally configured with a supply unit 20d for supplying a display unit 16d of the cooking system 10d. In the present exemplary embodiment, the induction heating element 30d is configured as a freestanding induction heating element 30d.

A setting down unit 24d has a pad unit 28d. In an operating state, the pad unit 28d is arranged between a cooking pot 26d, which in particular is part of the setting down unit 24d, and the hot plate 12d. The display unit 16d is integrated in the setting down unit 24d which is configured as the pad unit 28d.

A control unit 18d of the cooking system 10d operates the display unit 16d as a function of an operation request parameter. The operation request parameter is a user request relative to setting down in the region for setting down a cooking pot 14d (see FIGS. 20 to 23).

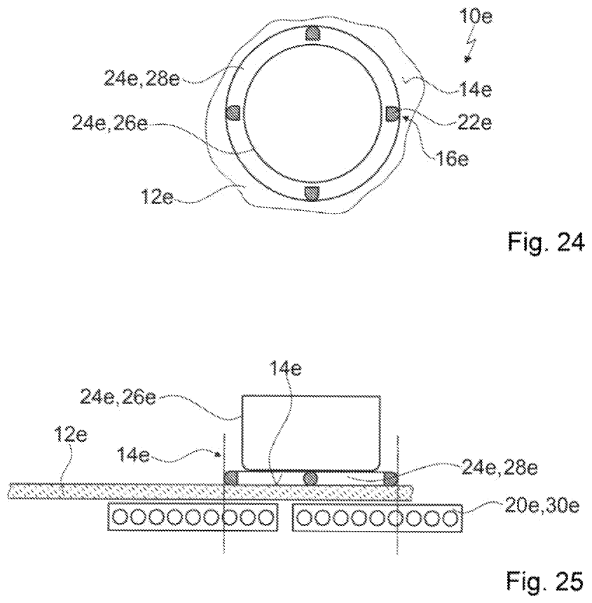

FIGS. 24 and 25 show a cooking system 10e with a hot plate 12e, which defines a region for setting down a cooking pot 14e, and with a plurality of induction heating elements 30e. In the present exemplary embodiment, the induction heating elements 30d are arranged in the form of a matrix. A display unit 16e of the cooking system 10e may, in particular, be supplied with energy by at least two induction heating elements 30e.

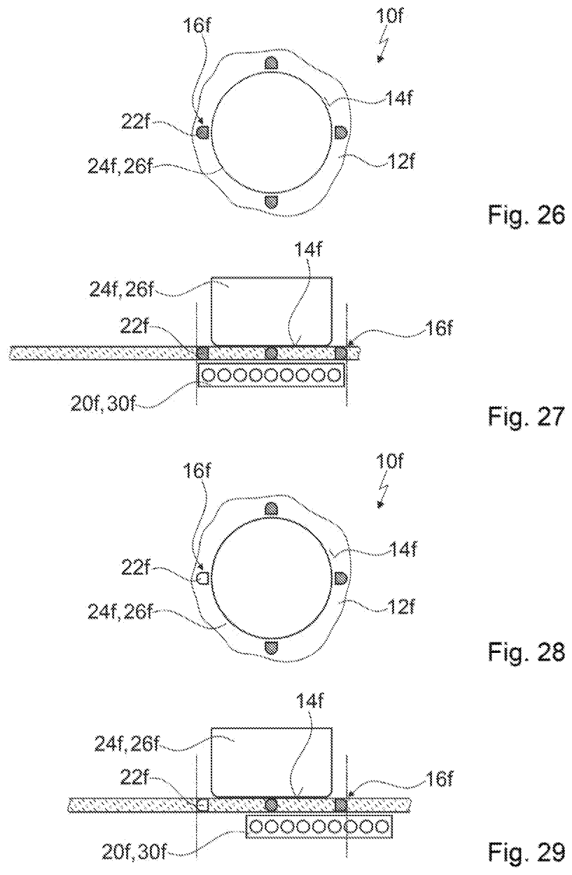

FIG. 26 shows a cooking system 10f with a hot plate 12f, which defines a region for setting down a cooking pot 14f, and with an induction heating element 30f which is arranged in an installed position below the hot plate 12f. In an installed position, a display unit 16f of the cooking system 10f is arranged below a region close to the region for setting down a cooking pot 14f. The display unit 16f is arranged around the induction heating element 30f, when being viewed in a vertical direction down onto a main extension plane of the hot plate 12f.

A control unit 18f of the cooking system 10f operates the display unit 16f as a function of an operation request parameter. The operation request parameter is a user request relative to setting down in the region for setting down a cooking pot 14f (see FIGS. 26 to 29).

### REFERENCE NUMERALS

10 Cooking system
12 Hot plate
14 Region for setting down a cooking pot
16 Display unit
18 Control unit
20 Supply unit
22 Lighting element
24 Setting down unit
26 Cooking pot
28 Pad unit
30 Induction heating element
32 Object
34 User interface

1-14. (canceled)

15. A cooking system, comprising:
a hot plate having a region for setting down of a cooking pot;
a display unit arranged at least partially in a region close to the region for setting down a cooking pot, when being viewed in a vertical direction onto a main extension plane of the hot plate; and
a control unit configured to operate the display unit in an operating state as a function of at least one operation request parameter.

16. The cooking system of claim 15, wherein the display unit includes a plurality of lighting elements, and further comprising a supply unit individually supplying in the operating state each of the lighting elements with energy.

17. The cooking system of claim 15, further comprising a setting down unit arranged in the operating state in the region for setting down a cooking pot.

18. The cooking system of claim 17, wherein the setting down unit is constructed to comprise the cooking pot.

19. The cooking system of claim 17, wherein the setting down unit comprises a pad unit arranged in the operating state between the cooking pot and the hot plate.

20. The cooking system of claim 17, wherein the display unit is at least partially integrated in the setting down unit.

21. The cooking system of claim 15, wherein the display unit is arranged in the operating state at least partially below the region close to the region for setting down a cooking pot.

22. The cooking system of claim 15, further comprising an induction heating element arranged in the operating state below the hot plate and supplying the display unit with energy.

23. The cooking system of claim 22, further comprising a setting down unit arranged in the operating state in the region for setting down a cooking pot, said induction heating element being configured such as to exclusively activate in the operating state lighting elements of the display unit in the region close to the region for setting down a cooking pot, when being viewed in a vertical direction onto a main extension plane of the hot plate and when the setting down unit is set down.

24. The cooking system of claim 15, wherein the operation request parameter is a user request relative to setting down in the region for setting down a cooking pot.

25. The cooking system of claim 15, wherein the operation request parameter is a user request relative to a cooking process.

26. The cooking system of claim 15, wherein the operation request parameter is a user request relative to a cooking recipe.

27. The cooking system of claim 15, wherein the operation request parameter is a user request to remove an undesired object from the region for setting down a cooking pot.

28. A method for operating a cooking system including a hot plate defining a region for setting down a cooking pot, said method comprising:
arranging a display unit at least partially in a region close to the region for setting down a cooking pot, when being viewed in a vertical direction down onto a main extension plane of the hot plate; and
outputting an operation request parameter with the display unit in an operating state.

29. The method of claim 28, further comprising individually supplying in the operating state each of a plurality of lighting elements of the display unit with energy.

30. The method of claim 28, further comprising supplying the display unit with an induction heating element arranged in the operating state below the hot plate.

31. The method of claim 30, wherein the induction heating element exclusively activates in the operating state lighting elements of the display unit in the region close to the region for setting down a cooking pot, when being viewed in a vertical direction onto a main extension plane of the hot plate.

32. The method of claim 28, wherein the operation request parameter is a user request relative to setting down in the region for setting down a cooking pot.

33. The method of claim 28, wherein the operation request parameter is a user request relative to a cooking recipe.

34. The method of claim 28, wherein the operation request parameter is a user request to remove an undesired object from the region for setting down a cooking pot.
